(19) United States
(12) Patent Application Publication
(10) Pub. No.: US 2014/0161466 A1
(43) Pub. Date: Jun. 12, 2014

(54) MULTIPLE MODE WIRELESS DATA LINK DESIGN FOR ROBUST ENERGY EFFICIENT OPERATION

(71) Applicant: Nabeel Agha Riza, Cork City (IE)

(72) Inventor: Nabeel Agha Riza, Cork City (IE)

(21) Appl. No.: 14/094,168

(22) Filed: Dec. 2, 2013

Related U.S. Application Data
(60) Provisional application No. 61/731,907, filed on Nov. 30, 2012.

(51) Int. Cl. H04B 10/114

(52) U.S. Cl. CPC H04B 10/1143
USPC 398/119

(57) ABSTRACT

The invention provides power smart in-door optical wireless link that provides lossless beam propagation between Transmitter (T) and Receiver (R) for changing link distances including in conditions of transmit and receive beam spoiling due to environmental effects. Each T/R unit uses a combination of fixed and variable focal length optics (called inverse adaptive optics) to smartly adjust the transmit beam laser beam propagation parameters of minimum beam waist size and its location to produce the optimal zero propagation loss coupling condition at the Receiver for the specific link distance.

### CROSS REFERENCE TO RELATED APPLICATION

This application claims the benefit of U.S. provisional application No. 61/731,907 filed on Nov. 30, 2012, which is incorporated by reference as if fully set forth.

### FIELD

The invention relates to optical wireless communications. In particular the invention relates to an in-door optical wireless link that provides lossless beam propagation between a Transmitter (T) and Receiver (R).

### BACKGROUND

Light based Free-Space Optical (FSO) communications dates back to Alexander Grahram Bell's photo-phone, demonstrated for voice communications in 1880. With the invention of various types of highly directional light sources such as the laser in the 1960s, Bell's vision for transporting information on a light beam became a reality and research work started to study the effects of light propagation and photon detection for information transfer [see R. S. Lawrence and J. W. Strohbehn, “A survey of clear-air propagation effects relevant to optical communications,” Proc. IEEE, vol. 58, no. 10, pp. 1523-1545, October 1970; J. R. Pierce, “Optical channels: Practical limits with photon counting,” IEEE Trans. Commun., vol. COM-26, no. 12, pp. 1819-1821, December 1978]. Because light beams in free-space can be highly effected by out-door conditions such as rain, air turbulence, clouds, etc, the prospect of using laser FSO communications for indoor and space applications was considered more practical from an engineering point-of-view.

Thus, it was realized in the late 1970's that diffused Infrared (IR) light much like Radio Frequency (RF) radiation filling a room could be used for wireless data communications [see F. R. Gfeller and U. H. Bapst, “Wireless in-house data communication via diffuse infrared radiation,” Proc. IEEE, vol. 67, pp. 1474-1486, November 1979]. This method using diffused light is also known as the Diffused Infrared Radiation (DFIR) indoor optical wireless technique and is very effective in preventing physical blocking of the receiver light and more tolerant to transmitter/receiver mobility. Because this method uses scattered light in room, it is highly inefficient and also limits data rates due to multipath effects. To counter these limitations of the DFIR indoor wireless method, highly directional light beam communication, also known as Line-of-Sight (LOS) infrared communications or Directed-beam IR (DBIR) technique, was proposed and demonstrated [see C. S. Yen and R. D. Crawford, “The Use of Directed Optical Beams in Wireless Computer Communication,” Proceeding of Globecom 85, New Orleans, 39.1.1-39.1.5, pp. 1181-1184, 1985; Y. Nakata, et al., “In-house wireless communication system using infrared radiation,” Proc. of the Seventh International Conference on Computer Communications, pp. 333-338, October 30-Nov. 2, 1985, Sydney, Australia]. This started an active period of research that continues today in both directed and non-directed IR FSO links, which include various designs such as using a continuously distributed spread-out beam or using a micro-cell based light pointing architecture to soften receiver alignment issues and using highly sensitive photo-detectors to maximize data rates [see T. S. Chu, M. J. Gans, “High Speed Infrared Local Wireless Communications,” IEEE Communications, vo 1.25, no. 8, pp. 1-10, August 1987; D. J. T. Heatley, D. R. Wisely, I. Neild and P. Cochrane, “A review of Optical Wireless,” British Telecom Engineering Journal, Vol. 17, W4, IEC825, 1993; J. M. Kahn, J. R. Barry, M. D. Audeh, J. B. Carruthers, W. J. Krause, and G. W. Marsh, “Non-directed infrared links for high capacity wireless LANs,” IEEE Personal Commun. Mag., vol. 1, May 1994; Peter P. Smyth, Philip L. Eardley, Kieran T. Dalton, David R. Wisely, Paul McKee, and David Wood, “Optical Wireless a Prognosis,” SPIE Proc. on Wireless Data Transmission, Vol 2601, pp 21 1-225, Philadelphia, October 1995; P Eardley, D Wisely, D Wood and P McKee, “Holograms for optical wireless LAN's”, IEE Proc. on Optoelectronics, Special Issue on Free Space Optical Communications, December 1995; D Wisely, “A 1 Gbit/s Optical Wireless Tracked Architecture for ATM Delivery”, IEE Colloquium, London, February '96; K. Nishida, “A proposal of multi beam transmitter for non-directed diffuse indoor optical wireless communication system,” Personal, Indoor and Mobile Radio Communications, vol. 1, pp. 242-246, 1996; D. Wisely and I. Neild, “A 100 Mbit/s tracked optical wireless telepoint,” Personal, Indoor and Mobile Radio Communications, vol. 3, pp. 964-968, 1997; David J. T. Heatley and Ian Neild, “Optical Wireless—The Promise and The Reality,” IEE Conf. Proc., 1999; R. Ramirez-Iniguez and R. J. Green, “Indoor optical wireless communications,” IEE Colloquium on Optical Wireless Communications, (Ref. no. 1999/128), pp. 14/1-14/7, 1999; S. Jivkova and M. Kavehrad, “Multi-spot diffusing configuration for wireless infrared access,” IEEE Trans. Commun., vol. 48, pp. 970-978, June 2000; D. C. O'Brien, G. E. Faulkner, K. Jim, E. B. Zyambo, D. J. Edwards, M. Whitehead, P. Stavrinou, G. Parry, J. Belton, M. J. Sibley, V. A. Lalithambika, V. M. Joyner, R. J. Samsudin, R. Atkinson, D. M. Holburn, and R. J. Mears, “High-speed integrated transceivers for optical wireless,” IEEE Commun. Mag., vol. 41, no. 3, pp. 58-62, 2003; M. O. Zaatari, “Wireless optical communications systems in enterprise networks,” The Telecommunications Review, pp. 49-57, 2003; A. Mandy and J. S. Deogun, “Wireless optical communications: A survey,” IEEE Wireless Communications and Networking Conference, Vol. 4, pages 2399-2404, 2004; K. Nonaka and Y. Isobe, “High speed optical wireless access with VCSEL-array beam micro-cell system,” ECOC 2004, pp. 127-128, Stockholm, 2004; K. Nonaka, Y. Shima, A. Posri, and M. Tachibana, “High speed optical micro-cell wireless system for moving user access terminal with VCSELs and receivers array,” LEOS Summer Topical Meetings, 2005, pp. 37-38, San-Diego, 2005; Charoen Tangtrongbenchasil, Yoichi Hamada, Toshihiro Kato, and Koji Nonaka, “Optical wireless communications and autonomous beam control moving user terminal,” IEICE Trans. Commun., Vol. E 90-b, No. 11 Nov. 2007; R. J. Green, H. Joshi, M. D. Higgins and M. S. Leeson, “Recent developments in indoor optical wireless Systems, IET Commun., 2, Vol. (1), pp. 3-10, 2008; Farhad Khozeimeh, and Steve Hranilovic, “Dynamic Spot Diffusing Configuration for Indoor Optical Wireless Access,” IEEE Transactions on Communications, VOL. 57, NO. 6, JUNE 2009; Neda Cvijetic, Dayou Qian, Jianjun Yu, Yue-Kai Huang, and Ting Wang, “Polarization-Multiplexed Optical Wireless Transmission With Coherent Detection.” IEEE/OSA Journal of Lightwave Technology, VOL. 28, NO. 8, Apr. 15, 2010].

The provided references include review papers in indoor optical wireless and highlight the international activity in this field including works in optimal optical wireless networking topologies [A. Kashyap, K. Lee, M. Kalantari, M. S Khuller, “Integrated topology control and routing in wireless optical mesh networks,” Elsevier Computer Networks Journal, 2007].

Agile spatially reconfigurable laser beams for forming a FSO communication network have been proposed previously for both space (i.e., inter-satellite) [for example N. A. Riza, “Switchboard in the sky: freespace optics platform for communications and processing,” IEEE LEOS Ann. Mtgs. Digest, December, 1998] and indoor [see N. A. Riza, “Reconfiguration optical wireless,” Lasers and Electro-Optics Society 1999 12th Annual Meeting, LEOS'99, vol. 1, pp. 70-71, 1999] wireless applications. Specifically, reference N. A. Riza, “Reconfiguration optical wireless,” Lasers and Electro-Optics Society 1999 12th Annual Meeting, LEOS'99, vol. 1, pp. 70-71, 1999 proposed a new hybrid indoor optical wireless method, now called Hybrid Diffused-LOS [see Farhad Khozeimeh, and Steve Hranilovic, “Dynamic Spot Diffusing Configuration for Indoor Optical Wireless Access,” IEEE Transactions on Communications, VOL. 57, NO. 6, JUNE 2009] as it is a combination of the DFIR and DBIR methods. Specifically, the Hybrid Diffused-LOS technique uses several (e.g., N=3) simultaneous wireless communication links with spatially different position transceiver locations to make the wireless connection robust to physical blocking yet optically efficient and having high date rate using the highly directed beams for communications.

Another hybrid optical wireless technique that has been proposed combines optical wireless with RF wireless [see S. Miyamoto, Y. Hirayama, N. Morinaga, “Indoor wireless local area network system using infrared and radio communications,” Proceedings of APCC/OECC '99 5th Asia Pacific Conference on Communications/Proc. of 4th Optoelectronics and Communications Conference, Beijing, China. 1999, Vol. 1, pp. 790-793; H. Izadpanah, T. Elbatt, V. Kukshya, F. Dolezal, and B. K. Ryu, “High-availability free space optical and RF hybrid wireless networks,” IEEE Wireless Networks, vol. 10, no. 2, pp. 45-53, 2003], including a hybrid optical-RF method with agile optical-RF beam pointing [see N. A. Riza, “Flexible Agile Optical-RF Antenna System,” SBIR Phase 1 Contract, US Air Force Wright Labs, AF 02-233, 2002]. The spatial agility of the FSO laser link comes from a variety of novel [see Z. Yaqoob, N. A. Riza, “Smart Free-Space Optical Interconnects and Communication Links using Agile WDM Transmitters”, 2001 Digest of the LEOS Summer Topical Meetings, 30 July-1 Aug. 2001; N. A. Riza, “Reconfiguration optical wireless,” Lasers and Electro-Optics Society 199912th Annual Meeting, LEOS'99, vol. 1, pp. 70-71, 1999] and classic (e.g., mirror) [see T.-H. Ho, S. D. Milner, and C. C. Davis, “Fully optical real-time pointing, acquisition, and tracking system for free space optical link,” SPIE, Free-Space Laser Communication Technologies XVII, G. Stephen Mecherle, Ed., vol. 5712, pp. 81-92, 2005] beam scanner optics that can be rapidly reconfigured to produce the desired FSO beam in space in the case that the original beam is physically blocked due to a moving indoor object.

Thus, high speed spatial agility of a FSO laser beam in combination with the Hybrid Diffused-LOS optical wireless method can provide improved link reliability, efficiency, and data rates when compared to pure DFIR or DBIR methods. Nevertheless, a problem with all LOS laser-based wireless links is the increasing loss of received light power for increasing link ranges due to beam diffraction effects. Ideally, one would like to capture as many photons as were transmitted by the laser beam, thus producing a lossless transmission channel for communications with minimal impact on link gain margin due to laser beam propagation. If such a lossless beam transmission was possible, the impact on overall data link design would be significant from a variety of aspects. For instance, one could design links using much lower optical power lasers for a given data rate making the transmission more eye safe and more efficient from an energy usage point-of-view. In addition, using lower power optics implies smaller size, weight, and volume of the electrical power supplies. One could also use the higher received optical powers to achieve greater data rates for longer ranges or operate in higher noise environments. Thus, from a link design engineer's perspective, having the ability to operate with the lowest beam propagation loss possible, in particular for a varying link range, is desirable.

Techniques that are a hybrid of LOS and DF modes have been proposed such as the method described in N. A. Riza, IEEE LEOS 12th Annual Meeting, 1, San Franscisco, 1999, that is now called Hybrid Diffused-LOS as in A. Mandy and J. S. Deogun, IEEE Wireless Comm. and Network Conf., 4, 2004. Additionally, the use of agile spatially reconfigurable optical beam forming to realize a FSO communication network and zero propagation link loss has been proposed for laser LOS links in N. A. Riza, IEEE LEOS 12th Annual Meeting, 1, San Franscisco, 1999; N. A. Riza, IEEE LEOS Society Ann. Meeting, 2, Orlando, 1998; N. A. Riza and S. A. Khan, Optics Communication, 257, 2006. This has led to the proposal of energy efficient LOS transmitter designs that adapt to allow for optimum power capture for a link with changing link length and adaptive search beams in this application and experimentally shown in P. J. Marraccini and N. A. Riza, Journal European Opt. Soc. JEOS:RP, 6, 2011. Another method keeps a constant link beam coverage area for changing link distances in K. Wang, A. Nirmalathas, C. Lim, and E. Skafidas, Optics Letters, 37, 2012. However for all of these methods there are tradeoffs. LOS communication is able to achieve high data rates, but is easily blocked. On the other hand, diffused light communication is robust to blocking and can be used for multiple users, but has greatly reduced data rates due to multipath effects. In addition, classic RF and ultrasound-based wireless communications are also of the diffused type giving link robustness, but with link range and bandwidth/multi-path limitations.

It is therefore an object to provide an optical wireless indoor link to overcome at least one of the above mentioned problems.

### SUMMARY

The invention provides a system and method comprising a module adapted to provide an optical wireless indoor data link, said module comprising:

a first light source adapted to transmit a beam of light;

a first concave lens; and

a first adjustable Variable Focus Lens, wherein the variable focal lens is configured to adjust the transmit beam size to produce an optimal zero propagation loss coupling condition at a receiver end for a specific link distance.

Hence, this application proposes the design of such a power smart optical wireless indoor link that can provide low beam propagation loss with changing link distances. Wave propagation physics for the Gaussian laser beam that is produced by the smart electronically controlled lens optics, in combination with passive lens optics is used to produce the lowest possible optical loss between the transmitter and receiver locations. The fundamental agile lens focal length conditions for minimum link loss are used. Application scenarios for the novel smart link include energy efficient internet data center server rack interconnects and indoor minimal blocking wireless laptop-type connections. The smart link has the ability to provide a wide area search beam for search and hand-shake operations with other receiving T/R units, easing alignment procedures and beam blocking instances.

Presented also is a microoptics-based novel design power smart dual-mode optical transmitter that can operate simultaneously in the Line-of-Sight (LOS) mode and the Diffuse (DF) Mode or switch between the two modes. The power-data rate flexible design allows high data rates through the LOS mode along with robustness to blocking via DF mode. A multiple mode wireless link design is also provided that uses four types of data carrier frequencies, specifically, ultrasonic wave, Radio Frequency Wave, Directed Laser wave, Diffused Light (e.g., LED) wave. All or a combination of these data carrier frequencies can be used to transfer information in a high data rate and robust non-blocking way. Optical wave requires a freespace wave travel medium but RF wave and ultrasound can propagate within a variety of media that are blocking for optical waves.

In one embodiment the variable focal lens is adapted to be adjusted so as to spread out the beam of light into a wider zone to locate a receiver module in a predefined area.

In one embodiment the variable focal lens is adapted to be adjusted so as to spread out the beam of light into a wider zone to locate a receiver module in a predefined area; and on locating the receiver module adjust the transmit beam size to produce an optimal zero propagation loss coupling condition at the receiver module for a specific link distance.

In one embodiment the adjustable variable focus lens comprises an electronic controller configured to adjust the transmit beam size by adjusting the variable focus lens.

In one embodiment the light source comprises a laser source.

In one embodiment the light source comprises a LED light source.

In one embodiment there is provided a scanning mirror positioned to reflect the light beam to a desired location to provide optimal beam alignment.

In one embodiment a computing device comprises a camera, said camera is adapted to survey possible blocking objects with a first module and adapted maintain a non-blocking smart link condition with a second module.

In one embodiment the computing device comprises at least one of: desktop computer, laptop computer, cellular phone or server device.

In one embodiment the module comprises a processor; a camera; a rechargeable battery and an energy harvester.

In one embodiment the energy harvester comprises a solar panel adapted to supply energy to the battery.

In one embodiment the energy harvester comprises a thermoelectric device adapted to convert heat emitted from the computing device to supply power to the battery.

In one embodiment the module cooperates with a pedestal platform adapted to allow vertical and rotational motion for non-blocking link establishment.

In one embodiment a second adjustable variable focus lens arranged in cascade with the adjustable variable focus lens.

In one embodiment a second concave lens arranged in cascade with the adjustable variable focus lens.

In one embodiment there is provided a CCD sensor array configured to correct for beam spoiling.

In another embodiment the module comprises:

a second light source adapted to transmit a second beam of light;

a second concave lens; and

a second adjustable Variable Focus Lens, wherein the variable focal lens is configured to adjust the second transmit beam size to provide dual mode operation.

In one embodiment there is provided a switch to control operation of the first and second light sources.

In one embodiment dual mode operation comprises a first mode such that the first light source provides a line of sight (LOS) mode and the second light source provides a diffusion (DF) mode.

In one embodiment the module is adapted to cooperate with one or more wall mounted diffusers.

In one embodiment a diffuser arranged to diffuse the light from the first light source prior to transmission.

In one embodiment the diffuser comprises an electronic programmable diffuser optic device.

In one embodiment the diffuser comprises a polymer dispersed liquid crystal device.

In a further embodiment there is provided a module comprising:

a first light source adapted to transmit a beam of light;

a first concave lens; and

a first adjustable Variable Focus Lens, wherein the variable focal lens is configured to adjust the transmit beam size to produce an optimal zero propagation loss coupling condition at a receiver end for a specific link distance.

In another embodiment there is provided a module adapted to provide an optical wireless indoor data link, said module comprising:

a first light source adapted to transmit a beam of light;

a first concave lens; and

a second concave Lens, wherein at least one lens is configured to move relative to the other lens and adjust the transmit beam size to produce an optimal zero propagation loss coupling condition at a receiver end for a specific link distance.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:—

FIG. 1 illustrates a smart wireless optical data communication link according to one embodiment where (a) Common Transmit (T) and Receive (R) Aperture smart T/R module design. (b) Independent T and R apertures smart T/R module design;

FIG. 2 illustrates using the smart optical wireless data link according to one embodiment. Shown is a configuration with stations located at different distances both in the horizontal and vertical directions.

FIG. 3 illustrates a Non-Blocking Optical Wireless Indoor Data Link using concept of hybrid diffused-LOS optical wireless via two simultaneous beams operating via a pair of common T/R aperture T/R data units, according to one embodiment. Optimally, T/R C1 and T/R C2 can be on the room roof for better non-blocking abilities. For better non-blocking probability, 3 or higher roof T/R C nodes can be added. B: Broadband Connection (cable/optical fiber); C: Electrical cable; M: Broadband Modem; L: Laptop; V: Video Camera with Laptop; E: Multi-Path Time Delay Electronic Equalizer.

FIG. 4 illustrates non-Blocking Optical Wireless Indoor Data Link using the concept of optical wireless relaying via multiple smart optical wireless T/R data units. B: Broadband Connection (cable/optical fiber); C: Electrical cable; M: Broadband Modem; L: Laptop; V: Video Camera with Laptop.

FIG. 5 illustrates an optical wireless interconnection network for an internet servers indoor data center, according to one embodiment. R: Rack of Servers. Each T/R sits on pedestal platform with vertical and rotational motion for non-blocking link establishment.

FIG. 6(a) illustrates a smart optical wireless T/R terminal for out-door applications with laser beam spoiling due to communication channel environmental effects, according to one embodiment. This design combines inverse AO with classic AO for optimal T/R beam conditioning. (b) The proposed Optional T/R terminal operational range control module.

FIG. 7(a) illustrates a dual mode transmitter operating simultaneously in LOS mode and diffuse light mode according to one embodiment; and (b) a transmitter design using a LED and a laser light source according to one embodiment.

FIG. 8 illustrates (a) Hybrid LOS-Diffused system where the ECVFL in combination with the xy-scan mirrors can be used to create LOS diffused light such as from walls or objects in the room such as wall mounted custom diffusers S1, S2, S3. In addition, the LOS connection is also engaged. Shown is operation of the LOS Diffuse mode and LOS mode. (b) Hybrid LOS-Diffused system where non-LOS diffuse mode is used in addition to LOS mode.

FIG. 9 illustrates a T/R module that can also deploy Electronically programmable diffuser optics (e.g., DIF1 and DIF2) such as a polymer dispersed liquid crystal device in the transmitter module to diffuse the light required for transmission with electronic control of the diffuser optic and its diffusing properties. Presence of dots in the diffuser optic indicated operation in the diffusing state versus the clear state when no dots are present in the optic. (a), (b), and (c) show various operations of the ECVFL and electronic diffuser in the T/R unit.

### DETAILED DESCRIPTION OF THE DRAWINGS

The invention provides an optical T/R design uses a positive convex lens with an ECVFL to form the SMF coupled module. Within the framework of paraxial optics and beam forming optics device limits, one is able to produce a zero propagation link coupling loss design for a given range of link distances. The invention makes use of recent advances in micro-devices such as laser pointer-like modules, micro-lenses, camera (cell phone type) Electronically Controlled Variable Focus Lenses (ECVFLs), and Micro-Electro-Mechanical Systems (MEMS) beam pointing micro-mirrors points to the realization of new micro-optics scale optical wireless Transmitter (T) and Receiver (R) modules that can be readily adapted for use in a smart low loss indoor application link design.

For example, the emergence of low cost visible light laser pointers and laser scanning based color projection displays points to the applicability of low power visible laser pointer-like sources for indoor optical wireless link applications. Thus, motivated by these recent innovations in micro-optics based sources, optics, and applications, the present invention provides a novel design of the smart link design using visible laser pointer-like micro-optic modules and related hardware such as cell phone based ECVFL using liquid lens technology. Hence, the application provides a new optical T/R module design suited for compact laser-pointer like source modules. In addition, this application also proposes novel applications using the new optical T/R module design using a negative lens and a ECVFL in addition to Adaptive Optics (AO) for receive-mode operations.

Note that visible light-based indoor wireless communications is being considered as an excellent alternative to IR-based optical wireless, given that visible light usage has benefits such as low cost sources, e.g., white light emission Light Emitting Diodes (LEDs), smaller T and R apertures via use of shorter wavelengths and easier beam alignment due to human and visible CCD camera observation of free-space beams [see J. Grubor, O. C. Gaete Jamett, J. W. Walewski, S. Randel, K.-D. Langer, “High-Speed Wireless Indoor Communication via Visible Light,” Wireless 2007; Dominic C. O'Brien, Lubin Zeng, Hoa Le-Minh, Grahame Faulkner, Joachim W. Walewski, Sebastian Randel, “Visible Light Communications: Challenges and possibilities,” IEEE, 2008]. In addition, low cost visible laser pointers have become available with good beam divergence and beam shape properties that can be exploited for short range indoor optical wireless links such as attempted in this application. Nevertheless, one must be careful about visible laser light eye safety issues when using laser pointer style sources. Hence visible laser power levels should be restricted to low power safe levels such as done in laser scanning pico-display applications [see James Alwan, “Eye Safety and Wireless Optical Networks,” AirFiber, Inc. Publication, April 2001; http://www.iec.ch]. Given that the smart optical link design provides the lowest propagation loss between a transmitter and receiver, one can indeed use the lowest laser power needed for a particular bit rate, hence helping the visible light eye safety issue. For instance, a Class 1 laser classification means it is allowed for normal use under all conditions and there is no possibility of eye damage [see ANSI classification scheme, ANSI Z136.1-1993, American National Standard for Safe Use of Lasers; USA Food and Drug Administration (FDA) provided Important Information for Laser Pointer Manufacturers]. This Class 1 case typically restricts 600 nm red laser light Continuous Wave (CW) power to 0.39 mW. Most laser pointers are classified as Class 2 lasers and are rated for visible (400 nm to 700 nm) CW operations with a maximum power of 1 mW taking into consideration the 0.25 seconds human eye blink reflex exposure time that inherently acts as a shutter to prevent damage to the eye [see ANSI classification scheme, ANSI Z136.1-1993, American National Standard for Safe Use of Lasers; USA Food and Drug Administration (FDA) provided Important Information for Laser Pointer Manufacturers]. Red laser pointers are available using both laser diodes (e.g., 645 nm) and Diode-Pumped Solid State Lasers (e.g., 671 nm). The present application will hence focus on visible laser pointer like sources for link design, although other eye safe band (e.g., 780 nm, 850 nm, 1300 nm, and 1550 nm) laser sources can also be applied to the smart link concept according to one embodiment.

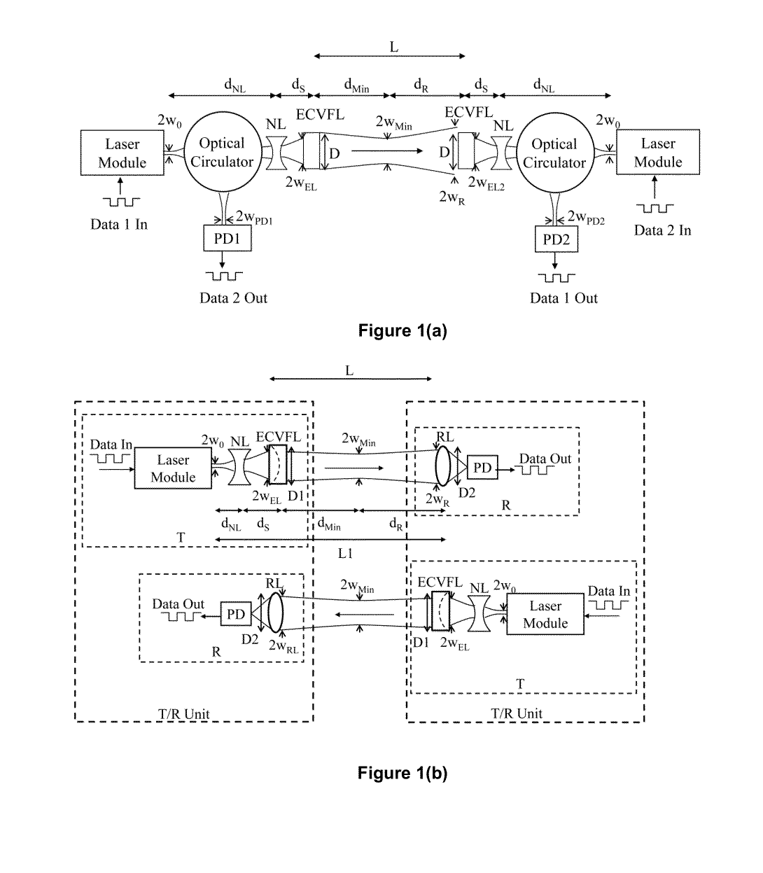

FIG. 1 shows a power smart optical wireless link design using two independent transceiver or T/R units according to one embodiment of the invention. The FIG. 1(a) link design allows simultaneous Transmit (T) and Receive (R) communications via a common T/R aperture that uses a Freespace Optics (FSO) circulator device to physically separate the T and R beam paths in each T/R unit. The T data signal in FIG. 1 electrically modulates the laser module. The received data signal is produced by the photodetector in the T/R unit. The T and R beams are spatially conditioned by the concave lens and the ECVFL in the T/R unit. The concave lens (also called the Negative Lens or NL) of focal length fNL is used to produce beam expansion of the Gaussian beam from the laser module so that the laser light completely illuminates the ECVFL aperture. Typically, the aperture of the ECVFL and other micro-optics in the T/R unit do not exceed a 5 mm diameter, giving a pencil-like compact design to the T/R units. The ECFVL's focal length F is controlled by an electrical signal (e.g., voltage level or drive frequency) that in-turn controls the minimum beam waist diameter 2 w_{Min} and its position d_{Min} with respect to the transmitter beam ECVFL location. Depending on the link distance L, F can be controlled to produce the desired Gaussian beam propagation such that it exhibits the self-imaging effect between the two communicating T/R units and thus forms a zero propagation loss link. Other notations for FIG. 1(a) are as follows:_{W0} : minimum beam waist radius at the laser module exit aperture; w_{EL}: beam waist radius at the transmit ECVFL;_{WEL2}: beam waist radius after the receive ECVFL; w_{R}: beam waist radius at the receive ECVFL; w_{PD1}: beam waist at Photo-Detector 1 (or PD1); w_{PD2}: beam waist at Photo-Detector 2 (or PD2); d_{NL}: distance from 2 w₀ position to NL; d_{S}: distance from NL to the ECVFL; d_{Min}: distance from the ECVFL to the 2 w_{Min} position; d_{R} : distance from 2 w_{Min} location to the T/R unit receiving the ECVFL conditioned laser beam; D: diameter of ECVFL aperture. For a symmetrical link providing the designed lossless beam propagation operations, d_{R}=d_{Min}. The FIG. 1(a) link can also be operated in an asymmetrical design where d_{R} is not equal d_{Min}. The asymmetrical case where d_{R}>d_{Min} implies that the beam diameter at the receiving ECVFL lens is larger than the ECVFL diameter at the distant T/R unit; hence the zero loss condition will not be met leading to increasing light propagation loss as d_{R} exceeds d_{Min}.

FIG. 1(b) shows an alternate link design with two T/R units communicating with physically separate T and R optical apertures. Hence each T/R unit contains physically separate transmitter and receiver modules. D1 and D2 are the diameters of the transmitter ECVFL and the receiver capture lens RL, respectively. The FIG. 1(b) T/R unit design is suitable when high optical isolation (>25 dB) is required between the T and R channels and when during an asymmetrical link operation, additional receive light capture is desired via a receive lens aperture size that exceeds the typical small ECVFL diameter.

The foundations of Gaussian beam propagation for the FIG. 1 smart link design are now determined. The novel optical designs of the present invention are shown in the FIGS. 1 to 6. The mathematics and physics to follow is given to explain the design operation of the FIG. 1 low loss link starting with the classic Gaussian laser beam's electric (optical) field represented according to [see H. Kogelnik and T. Li, “Laser beams and resonators,” Appl. Opt., Vol. 5, No. 10, pp. 1550-1567, 1966] by:

$$\begin{matrix}E ( r , z ) = {E}_{0} \frac{q ( 0 )}{q ( z )} {e}^{- \frac{j {kr}^{2}}{2 q ( z )}} , & ( 1 ) \\ where \frac{1}{q ( z )} = \frac{1}{R ( z )} - j \frac{λ}{π {w}^{2} ( z )} . & ( 2 )\end{matrix}$$

A is the wavelength of the light, k=2 π/λ, and r=\sqrt{x²+y²}, where x and y are the optical field plane Cartesian coordinates. The distance along the beam propagation axis is represented by z, w(z) is the 1/e2 beam radius at z, q(z) is the complex q-parameter, and R is the radius of curvature of the Gaussian beam wavefront. At the minimum beam waist of the Gaussian beam, the q-parameter is purely imaginary. The q-parameter at minimum beam waist of the laser cavity is equal to:

$${q}_{0} = j {z}_{0} = j \frac{π {w}_{0}^{2}}{λ} , \qquad ( 3 )$$

where z₀ is the Rayleigh range and w_{b} is the Gaussian beam waist at z₀. Using the ABCD matrix method, the q-parameter at another point along the beam propagation axis can be related by:

$${q}_{1} = \frac{A {q}_{0} + B}{C {q}_{0} + D} , \qquad ( 4 )$$

where A, B, C and D are the elements of the ABCD matrix. Substituting equation (3) into equation (4) and separating into real and imaginary parts leads to:

$${q}_{1} = \frac{A C {z}_{0}^{2} + BD}{{[ C {z}_{0} ]}^{2} + {D}^{2}} + j \frac{( AD - BC ) {z}_{0}}{{[ C {z}_{0} ]}^{2} + {D}^{2}} . \qquad ( 5 )$$

Now at d_{Min} since there is a minimum beam waist with q-parameter q_{Min}, the real part of equation (5) must be zero. This leads to:

ACz₀²+BD=0 (6)

Now referring to FIG. 1 (a) and (b), the ABCD matrix from minimum beam waist w₀ to w_{Min} is given by:

$$[ \begin{matrix}A & B \\ C & D\end{matrix} ] = [ \begin{matrix}1 & {d}_{min} \\ 0 & 1\end{matrix} ] \times [ \begin{matrix}1 & 0 \\ - \frac{1}{F} & 1\end{matrix} ] \times [ \begin{matrix}1 & {d}_{s} \\ 0 & 1\end{matrix} ] \times [ \begin{matrix}1 & 0 \\ - \frac{1}{{f}_{NL}} & 1\end{matrix} ] \times [ \begin{matrix}1 & {d}_{NL} \\ 0 & 1\end{matrix} ] , \qquad ( 7 )$$

This leads to the elements of the ABCD matrix being:

$$A = 1 - \frac{{d}_{S}}{{f}_{NL}} - \frac{{d}_{Min}}{{f}_{NL}} - \frac{{d}_{Min}}{F} + \frac{{d}_{S} {d}_{Min}}{{f}_{NL} F} \\ B = {d}_{NL} + {d}_{S} + {d}_{Min} - \frac{{d}_{NL} {d}_{S}}{{f}_{NL}} - \frac{{d}_{NL} {d}_{Min}}{{f}_{NL}} - \frac{{d}_{NL} {d}_{Min}}{F} - \frac{{d}_{S} {d}_{Min}}{F} + \frac{{d}_{NL} {d}_{S} {d}_{Min}}{{f}_{NL} F} \\ C = - \frac{1}{{f}_{NL}} - \frac{1}{F} + \frac{{d}_{S}}{{f}_{NL} F} \\ D = 1 - \frac{{d}_{NL}}{{f}_{NL}} - \frac{{d}_{NL}}{F} - \frac{{d}_{S}}{F} + \frac{{d}_{NL} {d}_{S}}{{f}_{NL} F} \qquad ( 8 )$$

Now substituting the ABCD elements into equation (6) and simplifying with respect to F leads to:

aF²+bF+c=0 (9)

Where:

$$a = [ \begin{matrix}{z}_{0}^{2} ( {d}_{Min} + {d}_{S} - {f}_{NL} ) + {d}_{NL}^{2} ( {d}_{S} + {d}_{Min} - {f}_{NL} ) + \\ {f}_{NL}^{2} ( {d}_{NL} + {d}_{S} + {d}_{Min} ) - 2 {d}_{NL} {f}_{NL} ( {d}_{S} + {d}_{Min} )\end{matrix} ] \\ b = [ \begin{matrix}{z}_{0}^{2} ( 2 [ {f}_{NL} ( {d}_{S} + {d}_{Min} ) - {d}_{S} {d}_{Min} ] - {d}_{S}^{2} - {f}_{NL}^{2} ) + \\ 2 {d}_{NL}^{2} ( {d}_{S} {f}_{NL} + {f}_{NL} {d}_{Min} - {d}_{S} {d}_{Min} ) - \\ 2 {f}_{NL}^{2} ( {d}_{NL} {d}_{S} + {d}_{NL} {d}_{Min} + {d}_{S} {d}_{Min} ) + \\ 4 {f}_{NL} {d}_{NL} {d}_{S} {d}_{Min} + 2 {d}_{NL} {d}_{S}^{2} {f}_{NL} - {f}_{NL}^{2} ( {d}_{NL}^{2} + {d}_{S}^{2} ) - {d}_{NL}^{2} {d}_{S}^{2}\end{matrix} ] \\ c = [ \begin{matrix}{d}_{Min} {z}_{0}^{2} ( {d}_{S}^{2} + {f}_{NL}^{2} - 2 {d}_{S} {f}_{NL} ) + \\ 2 {d}_{NL} {d}_{S} {d}_{Min} ( {f}_{NL}^{2} - {f}_{NL} {d}_{NL} - {f}_{NL} {d}_{S} ) + \\ {( {d}_{NL} {d}_{S} )}^{2} {d}_{Min} + {f}_{NL}^{2} {d}_{Min} ( {d}_{NL}^{2} + {d}_{S}^{2} )\end{matrix} ] \qquad ( 10 )$$

Note that larger input beam sizes allow for a larger achievable link distance. The input beam size w_{EL} can be found as follows:

$$[ \begin{matrix}{A}_{EL} & {B}_{EL} \\ {C}_{EL} & {D}_{EL}\end{matrix} ] = [ \begin{matrix}1 & {d}_{s} \\ 0 & 1\end{matrix} ] \times [ \begin{matrix}1 & 0 \\ - \frac{1}{{f}_{NL}} & 1\end{matrix} ] \times [ \begin{matrix}1 & {d}_{NL} \\ 0 & 1\end{matrix} ] = [ \begin{matrix}1 - \frac{{d}_{s}}{{f}_{NL}} & {d}_{s} + {d}_{NL} - \frac{{d}_{s} {d}_{NL}}{{f}_{NL}} \\ - \frac{1}{{f}_{NL}} & 1 - \frac{{d}_{NL}}{{f}_{NL}}\end{matrix} ] \qquad ( 11 )$$

Taking the inverse of equation (4) and substituting in equation (3) it can be shown that

$$\frac{1}{{q}_{EL}} = \frac{{A}_{EL} {C}_{EL} {z}_{0}^{2} + BD - j {z}_{0} ( {A}_{EL} {D}_{EL} - {B}_{EL} {C}_{EL} )}{{B}_{EL}^{2} + {( {z}_{0} {A}_{EL} )}^{2}} = \frac{1}{{R}_{EL} ( z )} - j \frac{λ}{π {w}_{EL}^{2} ( z )} . \qquad ( 12 )$$

Since the determinant of equation (11) is 1 [see H. Kogelnik and T. Li, “Laser beams and resonators,” Appl. Opt., Vol. 5, No. 10, pp. 1550-1567, 1966] and equating the imaginary parts of equation (12), the beam waist at the ECVFL is found to be:

$${w}_{EL} ( z ) = \sqrt{\frac{λ}{π} \frac{{( {A}_{EL} {z}_{0} )}^{2} + {B}_{EL}^{2}}{{z}_{0}}} . \qquad ( 13 )$$

The T/R unit link design parameters f_{NL}, d_{NL}, d_{S}, and d_{Min} should be chosen such that the beam radius w_{EL} described by equation (13) is smaller than the radius of the ECVFL. Then using equation (9), F can be solved for as follows:

$$F = \frac{- b \pm \sqrt{{b}^{2} - 4 a c}}{2 a} . \qquad ( 14 )$$

As F should be real, b²≧4 ac for a valid link design. Based upon the choice of F, the minimum beam waist size will be determined. Note that the smart link design analysis is done within the paraxial approximation, hence the focal length of the ECVFL used must satisfy F#≧1.67 [see N. A. Riza and S. A. Khan, “Ultra-low loss laser communications technique using smart beamforming optics,” Optics Communications, Vol. 257, Issue 2, pp. 225-246, 15 Jan. 2006; N. A. Riza and S. A. Khan, Erratum to “Ultra-low loss laser communications technique using smart beamforming optics” [Opt. Commun. 257 (2) (2006) 225-246], Optics Communications, Vol. 259, Issue 2, pp. 888-890, 15 Mar. 2006]. Using the two obtained solutions for F, one solves for the minimum beam waist w_{Min} by taking the imaginary part of equation (5). The determinant of an ABCD matrix describing Gaussian beam propagation is generally equal to 1 [see H. Kogelnik and T. Li, “Laser beams and resonators,” Appl. Opt., Vol. 5, No. 10, pp. 1550-1567, 1966], unless the input plane and output plane are media with different refractive indices. Therefore q_{Min} is given by:

$$\begin{matrix}{q}_{Min} = j \frac{{z}_{0}}{{[ C {z}_{0} ]}^{2} + {D}^{2}} = j \frac{π {w}_{Min}^{2}}{λ} & ( 15 ) \\ ⇒ {w}_{Min} = \sqrt{\frac{λ}{π} \frac{{z}_{0}}{{[ C {z}_{0} ]}^{2} + {D}^{2}}} & ( 16 )\end{matrix}$$

The size of w_{Min} should be real and less than w_{EL}. Since the purpose of the communication link is to achieve low optical power loss, the F solution that gives the lowest transmit aperture beam divergence should be used. Although both F solutions have the same loss in the symmetric link case, having a smaller beam divergence reduces the link loss for distances of d_{R}>d_{Min}. The divergence half angle within the paraxial approximation in the far field is given by [see H. Kogelnik and T. Li, “Laser beams and resonators,” Appl. Opt., Vol. 5, No. 10, pp. 1550-1567, 1966]:

$$θ = \frac{λ}{π {w}_{0}} \qquad ( 17 )$$

Hence the F solution that gives the larger w₀=w_{Min} minimum beam waist value will give the smaller transmit beam divergence and hence a reduced power loss if d_{R}>d_{Min}. To analyze the beam waist radius at the receiver, the q-parameter for the smart link receiver is defined as q_{R}. Using equation (2) and (4) gives:

$$\frac{1}{{q}_{R}} = \frac{{C}_{R} {q}_{0} + {D}_{R}}{{A}_{R} {q}_{0} + {B}_{R}} = \frac{1}{{R}_{R} ( z )} - j \frac{λ}{π {w}_{R}^{2} ( z )} , \qquad ( 18 )$$

where A_{R}, B_{R}, C_{R}, and D_{R} are the ABCD matrix elements from the laser module minimum beam waist to the receiving lens and is given by:

$$[ \begin{matrix}{A}_{R} & {B}_{R} \\ {C}_{R} & {D}_{R}\end{matrix} ] = [ \begin{matrix}1 & L \\ 0 & 1\end{matrix} ] \times [ \begin{matrix}1 & 0 \\ - \frac{1}{F} & 1\end{matrix} ] \times [ \begin{matrix}1 & {d}_{s} \\ 0 & 1\end{matrix} ] \times [ \begin{matrix}1 & 0 \\ - \frac{1}{{f}_{NL}} & 1\end{matrix} ] \times [ \begin{matrix}1 & {d}_{NL} \\ 0 & 1\end{matrix} ] . \qquad ( 19 )$$

Taking the imaginary parts of both sides of equation (18) and equating them gives the beam waist as:

$${w}_{R} ( z ) = \sqrt{\frac{λ}{π} \frac{{( {A}_{R} {z}_{0} )}^{2} + {B}_{R}^{2}}{{z}_{0}}} \qquad ( 20 )$$

For low smart link propagation loss, this beam waist radius w_{R} should be smaller than the diameter of receiving lens. For the case of a symmetric link, the beam waist at the output of the transmitting ECVFL and the size of the beam at the receiving lens should be the same. The smart link beam propagation can be compared to unconditioned Gaussian beam propagation over the distance L1, where L1=d_{NL}+d_{S}+L. Using equation (2) and (4) and the ABCD matrix for the length L1, the beam waist for the unconditioned Gaussian beam is given by:

$${w}_{N} ( z ) = {w}_{0} \sqrt{1 + {( \frac{L 1}{{z}_{0}} )}^{2}} . \qquad ( 21 )$$

Now that the beam waist at the receiver location for the smart link and unconditioned Gaussian beam propagation-based link are known, the advantage of the smart link design in terms of optical power at the receiving aperture of the T/R unit can be analyzed. The intensity of a Gaussian beam is proportional to the magnitude squared of the electric field (shown in Equation (1)) and is given by:

$$I ( r , z ) = {I}_{0} \frac{{w}_{0}^{2}}{{w}^{2} ( z )} {e}^{\frac{2 {r}^{2}}{{w}^{2} ( z )}} . \qquad ( 22 )$$

I₀ is the laser beam peak intensity at the w₀ location at the exit of the laser module, w(z) is the beam waist at a specific location given by equation (20) for the smart link and equation (21) for the unconditioned Gaussian beam. For a Gaussian beam, the receive aperture collected optical power is given by integrating over the area of the receiving aperture giving:

$$P ( z ) = 2 π {\int }_{0}^{a} {I}_{0} \frac{{w}_{0}^{2}}{{w}^{2} ( z )} {e}^{- \frac{2 {r}^{2}}{{w}^{2} ( z )}} d r . \qquad ( 23 )$$

Here a is the radius of the receiving aperture, i.e., the receiving lens in the T/R unit. To compare the results of the smart link and the unconditioned Gaussian beam propagation link, equation (23) can be normalized as follows:

$${P}_{Norm} ( z ) = \frac{{\int }_{0}^{a} {e}^{- \frac{2 {r}^{2}}{{w}^{2} ( z )}} d r}{{\int }_{0}^{∞} {e}^{\frac{2 {r}^{2}}{{w}^{2} ( z )}} d r} . \qquad ( 24 )$$

Hence, the normalized percentage optical power loss for the FSO link is given by:

P_{Loss}(z)=100[1−P_{Norm}(z)] (25)

Range symmetric links can be designed where the link range is defined between the L distance limits of Lₘᵢₙ≦L≦Lₘₐₓ. For example, a goal can be to design a link with 5 m≦L≦10 m range using hardware such a laser module with λ=632.8 nm and w₀=500 μm, and a NL with f_{NL}=−15 cm. For the T/R module design, d_{NL} should be less than the Rayleigh range z₀ as then the choice of d_{NL} has a minimal effect on w_{EL}. In fact, NL can be placed close to w₀ for a compact design. Thus d_{NL} is chosen to be 1 cm. Next an initial estimate for w_{EL} is made by setting w_{N}(z₀)=w_{EL} from Eqn (21) then solving w₀ in terms of w_{EL}, substituting this result into equation (3) and solving with z₀=Lₘₐₓ/2 leads to an initial estimate of w_{EL}=1.42 mm for 10 m link range. Now using Eqn. 11, solve Eqn. 13 for an initial estimate of dₛ that comes to be 27.06 cm. From computation of Eqn.13, one notes that the variation of dₛ greatly effects w_{EL} compared to d_{NL}. Next, the calculated dₛ estimate value of 27.06 cm plus the other design parameters and d_{Min}=Lₘₐₓ/2=5 m are substituted into equations (9) and (14) to provide a value for F that in this case comes out to be imaginary. As F was an imaginary value, one increases the estimate for dₛ to 27.43 cm at which value F became positive and equal to F=40.61 cm or F=40.51 cm. On the other hand, if solving Eqns. 9 and 14 gives a positive value for dₛ, one can decrease dₛ till it cannot be decreased further without F becoming imaginary. Note that the ECVFL chosen must satisfy the condition 2 w_{EL}<D. Next one solves Eqn. 9 and Eqn. 14 for the d_{Min}=Lₘᵢₙ/2=2.5 m which gives F=41.8 cm or F=36.51 cm. Using Eqn. 16, the w_{Min} for each focal length pair can be compared. Note that though both solutions of F are valid, the solutions of F that give the larger w_{Min} (via the longer F value) are chosen as they have less divergence and thus a smaller beam waist when d_{R}>d_{Min} allowing for low loss link operations when L>Lₘₐₓ. Hence, the ECVFL for the designed 5 m to 10 m link requires operations with 40.61 cm≦F≦41.8 cm, an achievable ECVFL device performance.

An important novel feature of FIG. 1 smart link is its ability to provide a wide area big search beam to establish a search and hand-shake operation with another remote receiving T/R unit. This search mode operation can be achieved by operating the ECFVL as a short focus convex lens so as to spread out the transmit beam into a wider zone to locate a possible T/R unit. On establishing an initial detection with a remote T/R unit, the ECVFL focal length is brought to a longer convex focal length for optimal low loss smart link operations. The expanded search beam mode can be used to create spatially controlled cells for optical illumination in an indoor wireless scenario.

Power Smart in-Door Optical Wireless Link—Novel Link Applications

Ideally from an eye safety and energy savings point of view, a wireless data link should be designed using the lowest laser power possible. In the case of visible light laser communications, the laser power for eye safe operations should be typically <250 μW. Based on the NRZ (Non-Return to Zero) format intensity modulated λ=660 nm laser diode beam detected using a photo-detector, the data rates achievable can be calculated for the required Bit Error Rates (BER). Ref. 49 states that for a BER of 10⁻⁹, a peak Signal-to-Noise Ratio (SNR) of 12 is required where the SNR is described by the expression [see R. H. Kingston, Optical Sources, Detectors, and Systems Fundamentals and Applications, Academic Press Inc., San Diego, Calif., 1995; D. Killinger, “Free space optics for laser communication through the air,” OSA Optics & Photonics New Magazine, Vol. 13, no. 10, pp. 36-42, 2002]:

$$SNR = \frac{{P}_{R}}{NEP \sqrt{B}} \qquad ( 26 )$$

Here NEP is the noise equivalent power in W/\sqrt{Hz} and is defined as the power in a 1 Hz Bandwidth B which gives a SNR=1. PR is the peak received optical power in Watts. Using Eqn. 27 for a New Focus Model 1577-A high speed photo-detector with a minimum NEP of 33 pW/\sqrt{Hz}, one requires a PR>39.6 μW for a 10 Gbps data link. This preliminary data link design analysis points to the promise of low power visible light short range indoor wireless communications for wide bandwidth information transfer including for applications described next.

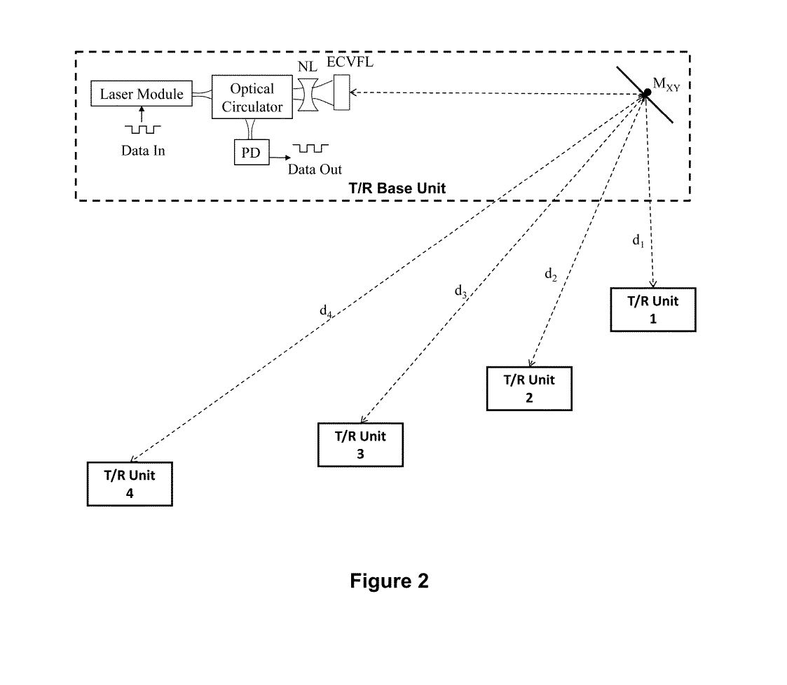

FIG. 2 shows a scenario with the T/R base station communicating data as needed to different T/R stations located at varying heights and horizontal distances in a Cartesian frame thus implying different link distances for the different stations. Here, the smart link optimizes its beam forming operations for highest photon throughput data transfer. Recall that a standard link is designed to operate for a certain link distance. If a standard link was designed to operate at distance d2, then there would be power loss for positions d3 and d4 since the receive aperture beam would be larger than the receiving lens. Note that if SMF coupling is used in these T/R units, the ECFVFL performs the vital function of producing the desired SMF mode matched beam that is required for capturing the maximum power into the SMF core. The xy scanning micromirrors, Mxy, in the T/R module units are used for optimal beam alignment and beam targeting to desired T/R station. Note that in principle, the FIG. 2 design using SMFs in the T/R units forms a 1×N (here N=4) FSO paths-based fiber-optic switch. This structure can also be extended to form a large scale N×M fiber-optic cross-connect switch with ideally zero optical propagation loss for any chosen path in the switch FOS interconnections [see N. A. Riza and M. J. Mughal, “An Approach towards the Holy Grail in All-Optical Circuit Switching: The Monster All-Optical Crossconnect,” SPIE Photonics North Conference, Paper 101-486, May 26-29, Montreal, Canada, 2003]. Without the SMFs as shown in FIG. 2, the design forms a freespace 1×N optical switch.

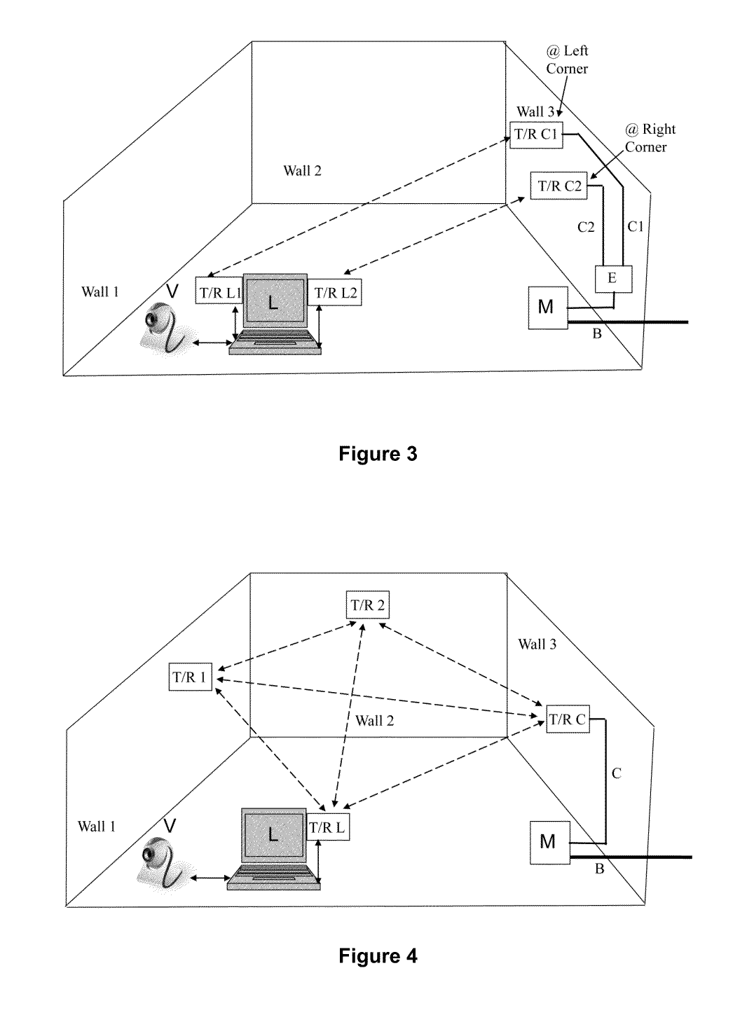

FIG. 3 shows a non-Blocking Optical Wireless Indoor Data Link using the concept of hybrid diffused-LOS optical wireless via two simultaneous beams operating via a pair of common T/R aperture T/R data units. Optimally, T/R C1 and T/R C2 can be on the room roof for better non-blocking abilities. For better non-blocking probability, three or higher roof T/R C nodes can be added.

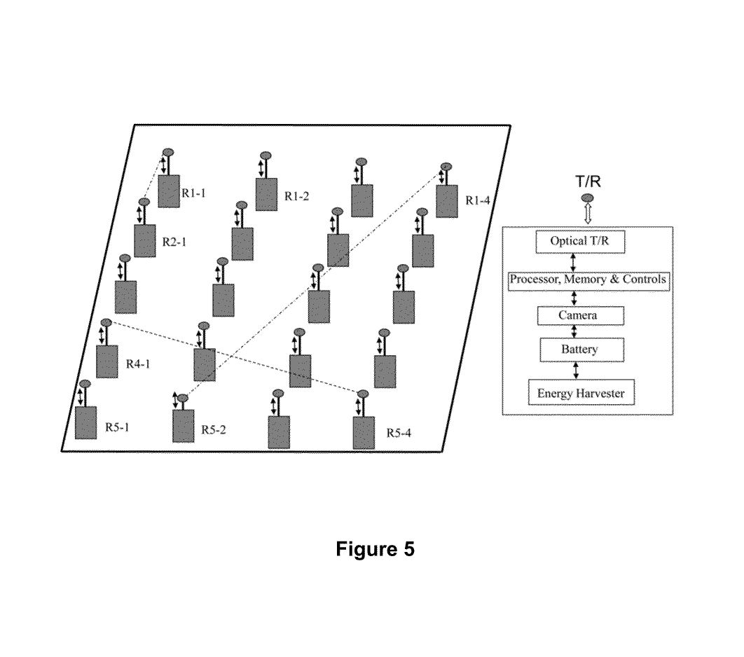

FIG. 4 shows a non-Blocking Optical Wireless Indoor Data Link using concept of optical wireless relaying via multiple smart optical wireless T/R data units. T/R1 and T/R2 use designs with separate T and R apertures while T/R L and T/R C can use modules with common T and R apertures. The system also uses the laptop's camera to survey possible blocking objects and maintain the non-blocking smart link condition, thus pre-planning for a possible blocking and hence setting up a new link path before the observed blocking happens. This is a novel use for an on-board camera such as on the laptop and helps in preventing beam blocking. Each T/R unit will have to store data in memory for retransmission to next relay node. An example data transmission sequence from the modem to the electrical cable to the laptop T/R unit is as follows: Transmit data from the electrical cable to the laptop via T/R C (T aperture) to T/R 1 to T/R L. To transmit data from the laptop to the electrical cable T/R unit, light data travels via T/R L to T/R 1 to T/R C. One can also go from the electrical cable to the laptop T/R unit via T/R C to T/R 2 to T/R L or T/R C to T/R 2 to T/R 1 to T/R L. Do note that the mobile terminal is not restricted to a laptop and can be other information units such as television displays, music entertainment electronics, and video storage hardware.

Next generation massive data centers, sometimes called cloud computing centers are being planned that have tens of thousands of servers in a warehouse size facility [see R. H. Katz, “Tech Titans Building Boom,” IEEE Spectrum, February 2009]. Typically, 250 servers will sit in a truck size container in rack style fittings with each rack containing 25 servers. The racks can be interconnected in the data center via a desired network topology such a ring network. Data centers are power hungry and thus every effort is being made to make the centers highly energy efficient. With the power of the low loss FSO interconnections, a highly interconnected and energy efficient non-blocking network can be created for fast data access.

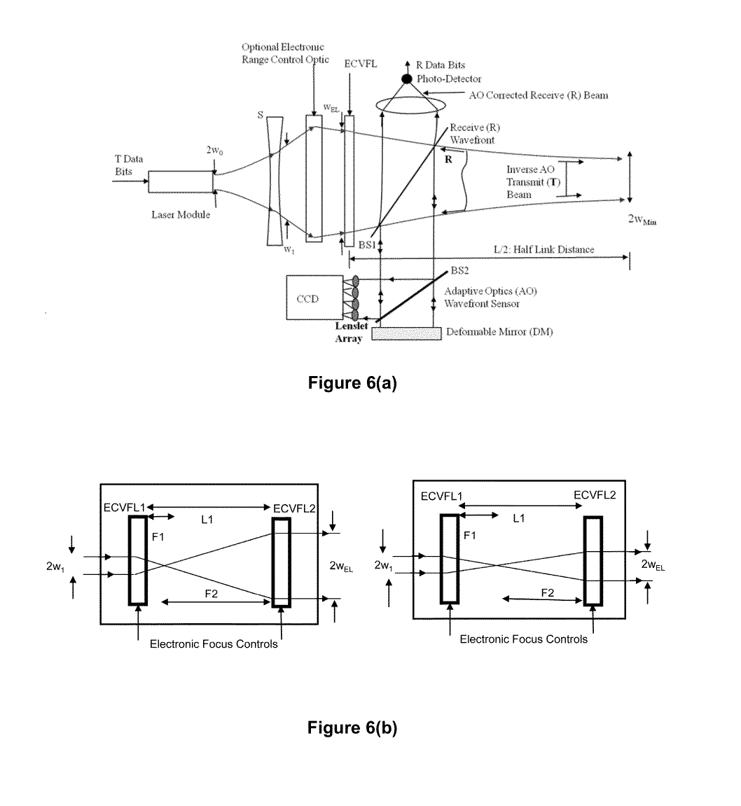

Hence, FIG. 5 shows an optical wireless interconnection network for an internet servers-based indoor air conditioned data center where R is a rack of servers. Each T/R unit sits on a pedestal platform with vertical and rotational motion for non-blocking link establishment. To make the unit energy efficient, the heat generated by the servers can be collected by a thermoelectric energy harvester that can be used to charge a battery. The battery is used to power the camera, control system, and optical T/R unit. These novel features of the T/R unit shown in FIG. 5 for the data center application empowers the next generation of data center communications.

Visible light FSO wireless has also been used for underwater communications such as remote connection to an autonomous vehicle or submarine communication [see B. Cochenour, L. Mullen, A. Laux, and T. Curran, “Effects of Multiple Scattering on the Implementation of an Underwater Wireless Optical Communications Link, MTS/IEEE Oceans 2006, pp. 1-6, 2006]. Hence, the smart link could also be used in short range underwater communications between two close docking vehicles that should consume minimal on-board power.

Out-door link applications implies the presence of laser beam spoiling conditions such as those due to air currents and thermal effects in the atmosphere and researchers have various methods to reduce environmental effects [see N. A. Riza, Editor, Special Issue on Wireless Optical Communications, SPIE Technical Group on Optics in Information Systems Newsletter, Vol. 12, No. 2, October 2001; Scott Bloom, Eric Korevaar, John Schuster, Heinz Willebrand, “Understanding the performance of free-space optics,” OSA Journal of Optical Networking, Vol. 2, No. 6, June 2003; T. Weyrauch and M. A. Vorontsov, “Freespace laser communications with adaptive optics: Atmospheric compensation experiments,” Editor A. K. Majumdar and J. C. Ricklin, Springer Science and Business Media, J. Optical & Fiber Communications Reports, No. 1, pp. 355-379, 2004; H. Henniger and O. Wilfert, “An introduction to free-space optical communications,” Radioengineering, Vol. 19, No. 2, pp. 203-212, June 2010 Kazuhiko Wakamori, Kamugisha Kazaura, and Ikuo Oka, “Experiment on Regional Broadband Network Using Free-Space-Optical Communication Systems,” IEEE/OSA Journal of Lightwave Technology, Vol. 25, No. 11, November 2007; Kiang Huat Heng, Wen-De Zhong, Tee Hiang Cheng, Ning Liu, and Yingjie He, “Beam divergence changing mechanism for short-range inter-unmanned aerial vehicle optical communications,” Applied Optics, Vol. 48, No. 8, 10 Mar. 2009]. Given such turbulent channel scenarios, system designers have resorted to using Adaptive Optics (AO) for receive beam processing.

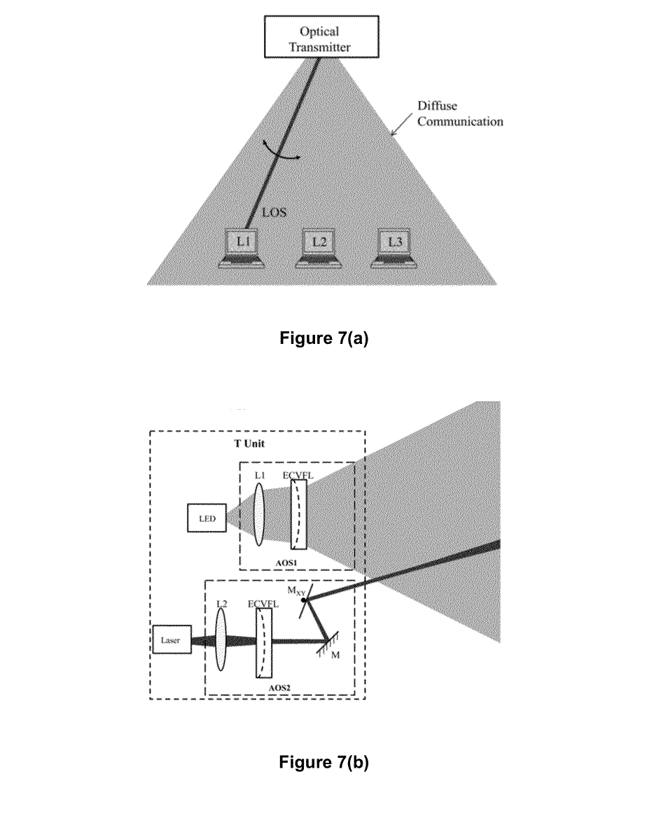

Hence, FIG. 6(a) shows a smart link T/R unit design that uses both preconditioning transmit beam optics (i.e., the ECVFL and fixed focal length optics S) as well as the AO optics (e.g., Hartmann-Shack Wavefront sensor) for receive beam processing. The combination of strong and weak lens beam forming optics within the paraxial approximation preconditions the transmitted Gaussian laser beam for optimal “slow” beam expansion, in effect this forms an Inverse-Adaptive Optics (I-AO) system. An optional electronically set link large range control optic module such as using additional programmable ECVFLs can be used to control the size of 2_{WEL} to make the T/R terminal adaptive in range over large changes in link distance. For example, if the FSO link distance varies from 10 m to 1000 m, the optimal 2_{WEL} varies from 5 mm to 50 mm or a 10× magnification provided by the FIG. 6(b) module [see S. A. Self, “Focusing of spherical Gaussian beams,” Appl. Opt., Vol. 22, No. 5, March 1983].

Specifically, FIG. 6(b) shows the proposed basic design of the optically reversible (T & R functions) terminal range control optic that uses two ECVFLs in cascade to deliver the required_{WEL} beam waist control. The module is shown for two settings of beam aperture (divergence) control showing the ease of electronic beam control for optimal FSO link performance. The basic principle is that the separation between the two ECVFL lenses is the sum of focal lengths of the two ECVFL focal lengths. Since the physical separation, L1, between the two programmable lenses is fixed, the focal lengths of the ECVFLs must be always adjusted to equal this distance so that L1=F1+F2, where F1 and F2 are the programmable focal lengths of ECVFL1 and ECFVL2, respectively. The beam magnification factor M=F2/F1 is from geometry. Of course, ECVFL1 and ECVFL2 must have apertures larger than the biggest desired 2 wEL. To get the desired M=10, one must use ECVFL1 and ECVFL2 with F2/F1=10, for example an ECVFL with focal length variation from 1 cm to 10 cm. Note that fast reset times for these ECVFLs is not critical for link operations. Designs using two ECVFL where L1≠F1+F2 can be analyzed using modified lens equations given by S. A. Self, “Focusing of spherical Gaussian beams,” Appl. Opt., Vol. 22, No. 5, March 1983. Hence the novel FIG. 6 T/R unit design can have a powerful impact in conditions where the transmit and receive beams suffer beam spoiling effects. The FIG. 6(b) two lens cascade module can be simply placed at the exit of a collimated light beam source (e.g., laser) to produce a desired focused beam spot at a desired distance where an optical receiver is placed for low loss optical wireless communications. For a symmetrical link design, this far-field focus spot will be half-way between the Transmitter and Receiver module. In the FIG. 6(b) design, one of the ECVFLs can also be a fixed focal length bias lens, such as ECFVL1 is a fixed concave lens like the design used in FIG. 1 and FIG. 2. Another design is to use ECVFL2 as a fixed focal length (e.g., convex lens) while keeping ECVFL1 as the variable focal length lens. The two cascade lens design separated by distance L1 is effectively a single focal length lens and hence light in the far-field focuses to a small spot at the effective single lens focal length distance. L1 and the ECVFL1 and ECVFL2 focal lengths can be optimized or changed to get the laser beam at the far-field focusing at the desired range spot. Inter lens distance L1 can be changed by physically moving the ECVFL1 and/or ECVFL2. The FIG. 6(b) 2-lens focusing module can produce far-field focused beams suited to the variable range required for a given wireless application, e.g., for sub-meters to tens of meters and beyond.

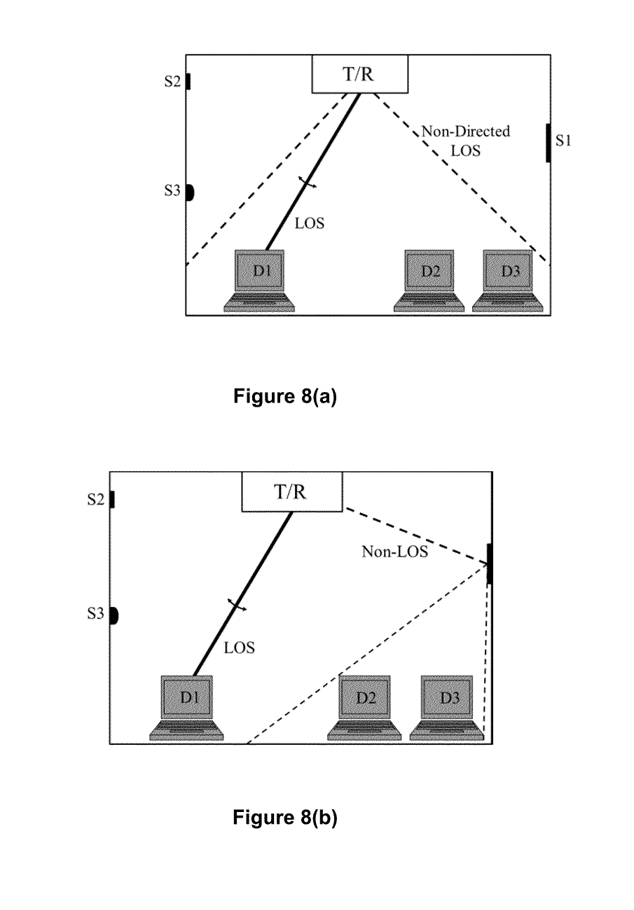

In another embodiment of the invention, a hybrid method shown in FIG. 7 is provided for achieving a balance between the data rate and non-blocking capabilities. With the increase in the number of mobile devices and applications requiring higher data rates, having a transmitter that can achieve the high data rates provided by the LOS mode and the non-blocking capabilities of the DF communication mode would be of great advantage, particularly in indoor applications such as data centres and mobile platforms where photon energy usage, data bandwidth, and robustness of link operations are critical.

FIG. 7 shows the optical transmitter using micro-optical components according to one embodiment of the invention. FIG. 7(a) shows an operating scenario for the optical transmitter. Here the optical transmitter is simultaneously operating in DF and LOS modes. The diffuse mode enables communication for multiple users over a wide area, while one laptop (L) is receiving higher speed communication via the LOS beam. The LOS beam can be directed to follow the laptop should it move. Should the LOS beam be blocked, communication is maintained via the DF mode until the LOS connection is re-established. The design has an energy efficient mode which enables the LOS or DF to be switched off when not in use. FIG. 7(b) shows the optical transmitter (T) where the micro-optic components, i.e., LED and laser are used for the DF and LOS modes, respectively. Each source has its own Agile Optical System (AOS) for forming the optical beams for the required distance. Other combinations of light sources (e.g., fibre coupled light sources, multiple lasers, multiple LEDs) can be used with proper design of the AOS. For simplicity, FIG. 7 does not show the optical receiver module. AOS1 and AOS2 consists of the micro-optics bias lens L1 and L2 and the micro-optic Electronically Controlled Variable Focus Lenses (ECVFLs) which form the optical beams for the required distance. The design of the LOS part of the transmitter to achieve varying link lengths is described in detail in P. J. Marraccini and N. A. Riza, Journal European Opt. Soc. JEOS:RP, 6, 2011 and N. A. Riza and P. J. Marraccini, IEEE IWCMC-2012, Cyprus, August 2012. In summary, there is provided a micro-optics-based dual mode LOS-Diffuse optical transceiver. This dual mode system has the benefit of high data rates provided by the LOS mode and the non-blocking capabilities of diffuse light communication making it adaptable to many communications scenarios. Applications for the link include mobile and fixed platforms in indoor environments.

It is well known that there is a trade-off between data bandwidth and optical power received in a photo-detector. Because one can control the light beam power density (e.g., mW/mm-square) incident on the photo-detector in the wireless link receiver by simply controlling the ECFVL in the link, one can optimize the use of optical power and data bandwidth in the optical wireless link system. With the two optical transmitter source system using two ECVFLs, each ECVFL can be programmed to provide the optimal optical power density on the receiver based on the data signal bandwidths of the two transmitters. Hence the ECVFL in the smart link also provides data rate based adaptive optical power control on the optical receiver for optimal received signal Signal-to-noise (SNR) ratio or Bit Error Rate (BER).

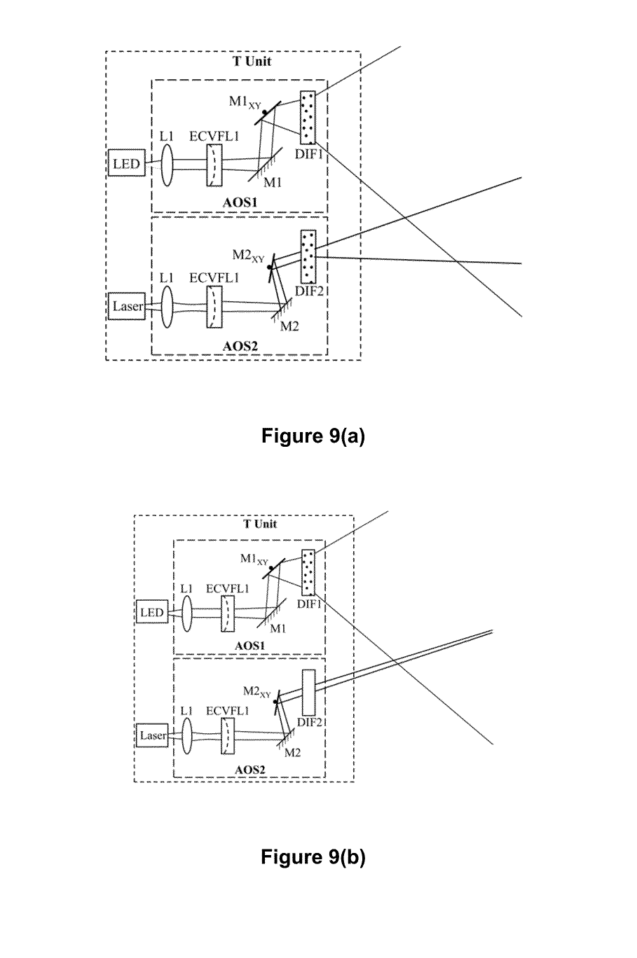

FIG. 8 (a) shows a Hybrid LOS-Diffused system where the ECVFL in combination with the xy-scan mirrors can be used to create LOS diffused light such as from walls or objects in the room such as wall mounted custom diffusers S1, S2, S3 of particular size, shape, and diffusing characteristics. Because the ECVFL controls the size of the light beam on a chosen diffuser (e.g., diffractive optic or diffusing plastic optic) on the wall, a variety of diffuser optic sizes and distances of diffuser to transmitter can be deployed for wireless communications. In addition, the LOS connection is also engaged. Shown is operation of the LOS Diffuse mode and LOS mode. FIG. 8(b) shows the Hybrid LOS-Diffused system where non-LOS diffuse mode is used in addition to LOS mode. In another embodiment it will be appreciated for FIG. 8(b) that the distance between the fixed diffuser optic on a wall or other physical structure can be at a remote distance from the T/R module that is outside the room shown but within LOS distance that is reachable by using a targeting laser beam within the T/R module. In effect, a laser beam is an efficient way to transport optical energy to a remote optical scattering site from where the light energy is sprayed onto an optical wireless user region for wireless broadcast mode operations such as emergency signal delivery in high EMI environments such as enclosed Faraday cages, e.g., ships, submarines, aircrafts, spacecrafts, automobiles, etc.

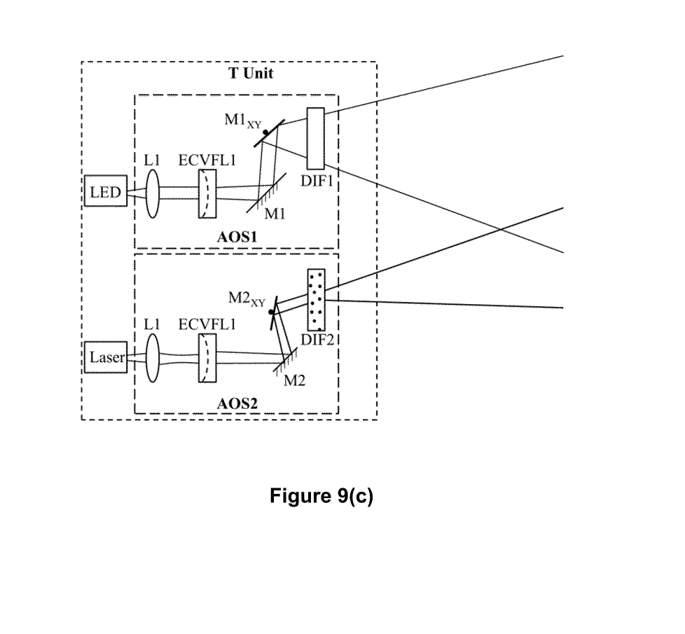

FIG. 9 shows that the T/R module can also deploy Electronically programmable diffuser optics (e.g., DIF1 and DIF2) such as a polymer dispersed liquid crystal device in the transmitter module to diffuse the light required for transmission with electronic control of the diffuser optic and its diffusing properties. Presence of dots in the diffuser optic indicated operation in the diffusing state versus the clear state when no dots are present in the optic. FIG. 9(a), (b), and (c) show various operations of the ECVFL and electronic diffuser in the T/R unit. Again, the ECVFL gives smartness to the wireless link via use of both non-LOS and LOS diffused light produced using customer diffuser programmable or non-programmable (fixed) optics. In effect, one controls the exposure of photons in the room based on the specific application real-time scenario where light beam blocking is possible and the smart optics counters this problem using the ECFVLs, fixed diffusers, scan mirrors, and electronic diffusers

In one embodiment there is provided a four carrier wireless link method to enable power efficient and blocking robust data wireless link design. The four carriers are RF (includes traditional RF bands plus TeraHertz band), ultrasonic wave (i.e., ultrasound), laser directed beam, and diffused light (e.g., LED) to transport the data modulation to a receiver that can detected these four types of carriers. All carriers can be used at the same time or a combination of carriers can be used. One can also use switching between carriers in a time scanned or space multiplexed method (i.e., where different spatial zones in the receive zone operate with different carrier waves).

For example, the described microoptics-based novel design power smart dual-mode optical transmitter is an example of a 2-mode (laser+LED) wireless system that can operate simultaneously in the Line-of-Sight (LOS) mode and the Diffuse (DF) Mode or switch between the two modes. The power-data rate flexible design allows high data rates through the LOS mode along with robustness to blocking via DF mode. Most mobile platforms like laptop computers also contain RF and ultrasound carrier transmit/receive (T/R) modules. Specifically, there are sound reception transducers/mikes for audio (sound wave) capture and also audio speakers (ultrasonic transducers) for sound wave generation. These sound T/R transducers can be optimized for use over a variety of ultrasonic frequencies to allow for low to medium data rate communications between T/R ports such as for robust handshake and alignment operations between two terminal, either fixed or mobile. Similarly, RF T/R modules such as traditional RF wireless can also be deployed for high data rate communications between terminals. In summary, four types of signal carriers can be deployed within the wireless network for robust and high data rate communications, including use with mobile terminals.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A module adapted to provide an optical wireless indoor data link, said module comprising:
a first light source adapted to transmit a beam of light;
a first concave lens; and
a first adjustable Variable Focus Lens, wherein the variable focal lens is configured to adjust the transmit beam size to produce an optimal zero propagation loss coupling condition at a receiver end for a specific link distance.

2. The module as claimed in claim 1 wherein the variable focal lens is adapted to be adjusted so as to spread out the beam of light into a wider zone to locate a receiver module in a predefined area.

3. The module as claimed in claim 1 wherein the variable focal lens is adapted to be adjusted so as to spread out the beam of light into a wider zone to locate a receiver module in a predefined area; and on locating the receiver module adjust the transmit beam size to produce an optimal zero propagation loss coupling condition at the receiver module for a specific link distance.

4. The module as claimed in claim 1 wherein the adjustable variable focus lens comprises an electronic controller configured to adjust the transmit beam size by adjusting the variable focus lens.

5. The module as claimed in claim 1 wherein the light source comprises a laser source.

6. The module as claimed in claim 1 wherein the light source comprises a LED light source.

7. The module as claimed in claim 1 comprising a scanning mirror positioned to reflect the light beam to a desired location to provide optimal beam alignment.

8. The module as claimed in claim 1 wherein a computing device comprises a camera, said camera is adapted to survey possible blocking objects with a first module and adapted maintain a non-blocking smart link condition with a second module.

9. The module as claimed in claim 1 wherein a computing device comprises a camera, said camera is adapted to survey possible blocking objects with a first module and adapted maintain a non-blocking smart link condition with a second module and the computing device comprises at least one of: desktop computer, laptop computer, cellular phone or server device.

10. The module as claimed in claim 1 said module comprising a processor; a camera; a rechargeable battery and an energy harvester.

11. The module as claimed in claim 1 said module comprising a processor; a camera; a rechargeable battery and an energy harvester and wherein the energy harvester comprises a solar panel adapted to supply energy to the battery.

12. The module as claimed in claim 1 said module comprising a processor; a camera; a rechargeable battery and an energy harvester and wherein the energy harvester comprises a thermoelectric device adapted to convert heat emitted from the computing device to supply power to the battery.

13. The module as claimed in claim 1 wherein the module cooperates with a pedestal platform adapted to allow vertical and rotational motion for non-blocking link establishment.

14. The module as claimed in claim 1 comprising a second adjustable variable focus lens arranged in cascade with the adjustable variable focus lens.

15. The module as claimed in claim 1 comprising a second concave lens arranged in cascade with the adjustable variable focus lens.

16. The module as claimed in claim 1 comprising a CCD sensor array configured to correct for beam spoiling.

17. The module as claimed in claim 1 further comprising
a second light source adapted to transmit a second beam of light;
a second concave lens; and
a second adjustable Variable Focus Lens, wherein the variable focal lens is configured to adjust the second transmit beam size to provide dual mode operation.

18. The module as claimed in claim 17 comprising a switch to control operation of the first and second light sources.

19. The module as claimed in claim 17 wherein dual mode operation comprises a first mode such that the first light source provides a line of sight (LOS) mode and the second light source provides a diffusion (DF) mode.

20. The module as claimed in claim 1 wherein the module is adapted to cooperate with one or more wall mounted diffusers.

21. The module as claimed in claim 1 further comprising a diffuser arranged to diffuse the light from the first light source prior to transmission.

22. The module as claimed in claim 1 further comprising a diffuser arranged to diffuse the light from the first light source prior to transmission wherein the diffuser comprises an electronic programmable diffuser optic device.

23. The module as claimed in claim 1 further comprising a diffuser arranged to diffuse the light from the first light source prior to transmission wherein the diffuser comprises a polymer dispersed liquid crystal device.

24. A module comprising:
a first light source adapted to transmit a beam of light;
a first concave lens; and
a first adjustable Variable Focus Lens, wherein the variable focal lens is configured to adjust the transmit beam size to produce an optimal zero propagation loss coupling condition at a receiver end for a specific link distance.

25. A module adapted to provide an optical wireless indoor data link, said module comprising:
a first light source adapted to transmit a beam of light;
a first concave lens; and
a second concave Lens, wherein at least one lens is configured to move relative to the other lens and adjust the transmit beam size to produce an optimal zero propagation loss coupling condition at a receiver end for a specific link distance.
